(19) United States
(12) Patent Application Publication
(10) Pub. No.: US 2006/0101414 A1
(43) Pub. Date: May 11, 2006

(54) System and method for automatically generating self-checking software

(76) Inventor: Stephen Poole, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/247,790

(22) Filed: Oct. 11, 2005

(30) Foreign Application Priority Data
Oct. 21, 2004 (GB) 0423357.3

(51) Int. Cl. G06F 9/44; G06F 11/00

(52) U.S. Cl. 717/127; 717/106; 714/38

(57) ABSTRACT

Generates self-checking software by providing characteristics of a specification; traversing points in state space defined by the characteristics to generate stand-alone test code; determining if the generated code is deterministic; and forming expected results of the test code into a standalone, self-checking body of test cases. The expected results may be merged back into randomly generated test cases to form the standalone, self-checking body of test cases.

### FIELD OF THE INVENTION

The invention relates to testing of software, and particularly automated testing of software.

### BACKGROUND

The discovery of differences in operation between various software implementations of a specification is a difficult and time consuming process. There are two existing approaches to solving this problem. These are: A) Create a Test Compatibility Kit (TCK) that embodies the specification, or B) Create a Test Engine that knows the “rules” of the specification, and have this engine drive the implementation in some dynamic way. Both of these solutions have weaknesses. For the TCK solution, the major issue (1) is whether or not the TCK is sufficient to provide complete coverage of the specification; in most cases, it is not. In most situations additional test cases need to be generated to augment the TCK. Most notably would be the (2) generation of more extensive user scenario test cases. The additional test cases produced then have to be (3) maintained as the specification evolves, which can be a significant effort. There is a similar issue with the Test Engine in that it too must have a sufficient set of information about the expected behavior of the implementation. Additionally (4), the Test Engine approach makes it difficult to provide test cases to developers, because the Test Engine tests in a dynamic, interactive manner.

Generation of self-checking test cases is known, for instance, from the paper entitled “Automatic generation of random self-checking test cases,” which is available at website address http://www.research.ibm.com/journal/sj/223/ibmsj2203G.pdf.

Also, from US patent publication 2003/0233653 there is known a scheme for automated Function Verification Testing (FVT) test generation by distributed processing among a master and one or more slave Java™ Virtual Machines (JVMs) which communicate via Remote Method Invocation (RMI). Using reflection analysis, the master sequentially tests each of a plurality of classes (software functions), instructs the slave to test each of the plurality of classes, compares the results of the testing at the master and slave, and in dependence thereon adds the class to a pool of classes for subsequent use.

However, these known approaches have the disadvantages that they are either not stand-alone (some sort of database being required to provide expected answers), are not completely self-checking, or use a model to describe the expected behavior.

A need therefore exists for a system and method for automatically generating self-checking software wherein the abovementioned disadvantages may be alleviated.

### SUMMARY

In accordance with a first aspect of the present invention, there is provided a system for automatically generating self-checking software as claimed in claim 1.

In accordance with a second aspect of the present invention there is provided a method for automatically generating self-checking software as claimed in claim 6.

### BRIEF DESCRIPTION OF THE DRAWINGS

One system and method for automatically generating self-checking software incorporating the present invention will now be described, by way of example only, with reference to the accompanying drawings, in which:

FIG. 1 shows a block schematic illustration of a system for automatically generating self-checking software in a networked computer arrangement;

FIG. 2 shows a flow chart illustrating the method followed by a computer in the system of FIG. 1 to generate self-checking software; and

FIG. 3 shows a flow chart illustrating a particular example of self-checking software generation in the system of FIG. 1.

### DETAILED DESCRIPTION

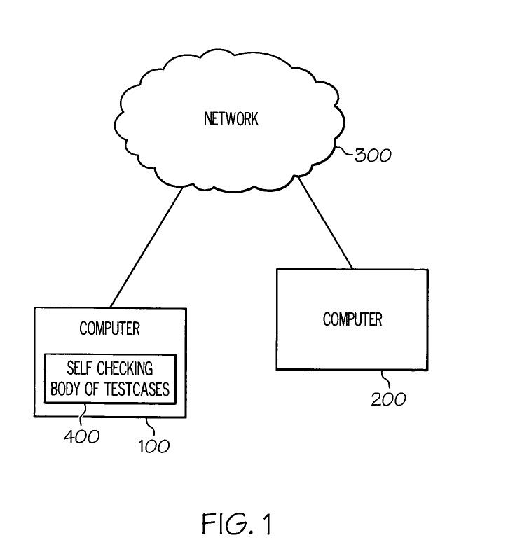

Referring firstly to FIG. 1, a novel system for automated generation of self-checking software is based on a software (e.g., Java) application that runs on processors (not shown) in one or more computers 100, 200 which are coupled to a computer network shown generally as 300.

The computer 100 (and/or 200) runs the Java application to automatically generate a standalone, self-checking body 400 of test cases as follows.

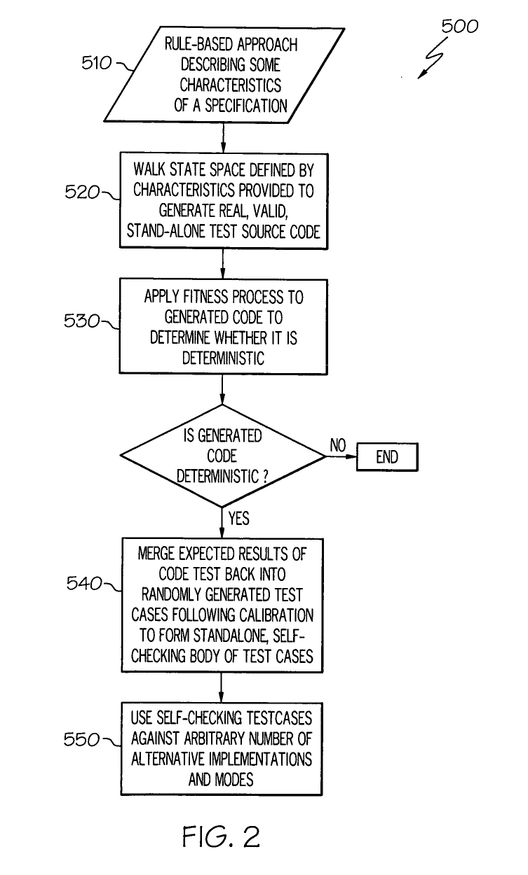

Referring also to FIG. 2, the method 500 employed to generate the standalone, self-checking body 400 of test cases starts with a rule-based approach to describe some characteristics of a specification 510. This may be as simple as naming functions. These characteristics provide the definition of a state space that is then ‘walked’ 520 (i.e., points in the state space are traversed) in as broad or narrow a way as required to generate real, valid, stand-alone source code. This source code is compiled and executed, and will be self-checking, i.e., it will already ‘know’ what the answer should be when a state change takes place. A fitness process is applied 530 to this generated code to determine if it is deterministic (non-deterministic code, for example where timestamps are generated, is not suitable in this environment). The code generated is also designed to always terminate. Because the scale and complexity of the code generated can be managed, it is possible to generate testcases that range from Unit Test equivalents right up to complex Use Cases.

The expected results of the test are merged 540 back into randomly generated test cases following calibration to form the standalone, self-checking body of test cases 400. It will be understood that calibration is the process of executing the generated test cases against a predefined ‘oracle.’ This oracle (which may be an alternative reference implementation of the system under test or a predictive modeling system) is assumed to be always correct. Thus, the expected behavior of the test case is determined ahead of time, before its execution against the test system.

Once the body of self-checking testcases is produced, they can be used (individually or together) against an arbitrary number of alternative implementations and modes (on the computer 100 or other computers such as the computer 200). Since each testcase is stand-alone, it can be provided to implementation developers to help diagnose their failures.

It will be understood that that this scheme for automated generation of self-checking software provides a number of advantages over the prior art discussed above, which advantages maybe summarized as follows:
Issue (1) is addressed in that an arbitrarily large number of testcases can be generated that capture the actual behavior of an implementation, behavior which can then be tested against alternative implementations.
Issue (2) is addressed in that arbitrarily large testcases can be generated that combine as much behavior from the specification as required.
Issue (3) is addressed in that generated testcases do not have to maintained. In the event that the specification is changed, the rules engine is updated and new test cases are generated.
Issue (4) is addressed in that stand-alone testcases are generated that can be provided to the specification implementer.

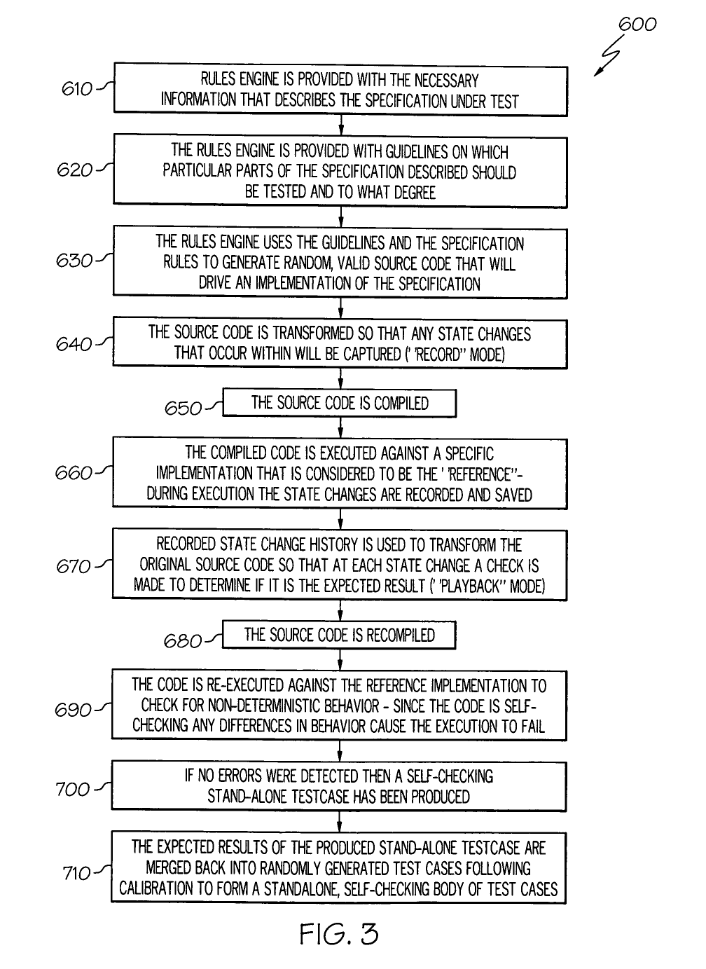

Referring now to FIG. 3, a particular example of the above scheme is described illustrated by the method 600. In block 610, a rules engine is provided with the necessary information that describes the specification under test. The rules can be as narrow or as wide as required. For instance it is quite possible to have “negative” rules that describe what should not be possible. In block 620, the rules engine is provided with guidelines on which particular parts of the specification described should be tested and to what degree.

In block 630, the rules engine uses the guidelines and the specification rules to generate random, valid source code that will drive an implementation of the specification. The source code generated is designed to always complete (no infinite loops, etc.) and to complete within a reasonable period (the total number of executed statements is controlled; when reached; the program is designed to gracefully terminate).

In block 640, the source code is transformed so that any state changes that occur within will be captured. This is the “record” mode. In block 650, this source code is compiled. In block 660, the compiled code is executed against a specific implementation (optionally in a specific operating mode) that is considered to be the “reference”. During execution the state changes are recorded and saved.

In block 670, the recorded state change history is used to transform the original source code so that at each state change a check is made to determine if it is the expected result. This is the “playback” mode. In block 680, the source code is recompiled.

In block 690, the code is now re-executed against the reference implementation to check for non-deterministic behavior. Since the code is self-checking any differences in behavior will cause the execution to fail. In block 700, if no errors were detected, a self-checking stand-alone testcase has been produced. In block 710, the expected results of the stand-alone testcase are merged back into randomly generated test cases following calibration to form a standalone, self-checking body of test cases.

It will be appreciated that the methods described above for automatic generation of self-checking software is (as mentioned above) be carried out in software running on a processor in the computer, and that the software may be provided as a computer program element carried on any suitable data carrier (not shown) such as a magnetic or optical computer disc.

It will be understood that the system and method for automatically generating self-checking software described above advantageously provides a solution that: produces testcases that are completely stand-alone, is completely self-checking in that the testcases record real behavior including exceptions, and does not depend on a model but uses a real reference implementation.

What is claimed is:

1. A system for automatically generating self-checking software, comprising:
means for providing characteristics of a specification;
means for traversing points in state space defined by the characteristics to generate stand-alone test code;
means for determining if the generated test code is deterministic; and
means for forming expected results of the test code into a standalone, self-checking body of test cases.

2. The system according to claim 1, wherein the means for forming comprises means for merging expected results of the test code into randomly generated test cases to form a standalone, self-checking body of test cases.

3. The system according to claim 1, wherein the means for providing characteristics of a specification comprises means for providing a rules engine.

4. The system according to claim 1, wherein the means for traversing points in state space defined by the characteristics to generate stand-alone test code further comprises:
means for generating test source code;
means for first transforming the generated test source code so that any state changes occurring therein will be captured;
means for compiling the transformed, generated source code;
means for executing the compiled code against a reference implementation and recording the state changes;
means for using the state change record to further transform the generated source code so that at each state change a check is made to determine if the result is expected; and
means for recompiling the further transformed, generated source code.

5. The system according to claim 4, wherein the means for determining if the generated code is deterministic comprises means for executing the recompiled code against the reference implementation, and means for detecting error in the execution of the recompiled code.

6. A method of automatically generating self-checking software, comprising:
providing characteristics of a specification;
traversing points in state space defined by the characteristics to generate stand-alone test code;
determining if the generated code is deterministic; and
forming expected results of the test code into a standalone, self-checking body of test cases.

7. The method according to claim 6, wherein forming expected results comprises merging expected results of the test code into randomly generated test cases to form a standalone, self-checking body of test cases.

8. The method according to claim 6, wherein providing characteristics of a specification comprises providing a rules engine.

9. The method according to claim 6, wherein traversing points in state space defined by the characteristics to generate stand-alone test code further comprises:
generating test source code;
transforming the generated source code so that any state changes occurring therein will be captured;
compiling the transformed, generated source code;
executing the compiled code against a reference implementation and recording the state changes;
using the state change record to further transform the generated source code so that at each state change a check is made to determine if the result is expected; and
recompiling the further transformed, generated source code.

10. The method according to claim 9, wherein determining if the generated code is deterministic comprises executing the recompiled code against the reference implementation; and detecting error in the execution of the recompiled code.

11. A computer program product for automatically generating self-checking software, the computer program product comprising a computer readable medium having computer readable program code tangibly embedded therein, the computer readable program code comprising:
computer readable program code configured to provide characteristics of a specification;
computer readable program code configured to traverse points in state space defined by the characteristics to generate stand-alone test code;
computer readable program code configured to determine if the generated code is deterministic; and
computer readable program code configured to form expected results of the test code into a standalone, self-checking body of test cases.

12. The computer program product of claim 11, wherein the computer readable program code configured to form expected results comprises computer readable program code configured to merge expected results of the test code into randomly generated test cases to form a standalone, self-checking body of test cases.

13. The computer program product of claim 11, wherein the computer readable program code configured to provide characteristics of a specification comprises computer readable program code configured to provide a rules engine.

14. The computer program product of claim 11, wherein the computer readable program code configured to traverse points in state space defined by the characteristics to generate stand-alone test code further comprises computer readable program code configured to:
generate test source code;
transform the generated source code so that any state changes occurring therein will be captured;
compile the transformed, generated source code;
execute the compiled code against a reference implementation and record the state changes;
use the state change record to further transform the generated source code so that at each state change a check is made to determine if the result is expected; and
recompile the further transformed, generated source code.

15. The computer program product of claim 11, wherein the computer readable program code configured to determine if the generated code is deterministic comprises computer readable program code configured to execute the recompiled code against the reference implementation and detect error in the execution of the recompiled code.
